(19) United States
(12) Patent Application Publication
(10) Pub. No.: US 2010/0086753 A1
(43) Pub. Date: Apr. 8, 2010

(54) FOILED ARTICLES AND METHODS OF MAKING SAME

(76) Inventors: Wade Johnson, North Mankato, MN (US); David Spangenberg, Eagle Lake, MN (US); Martin Koebel, North Mankato, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/244,631

(22) Filed: Oct. 2, 2008

(51) Int. Cl. B32B 3/10; G03G 13/16

(52) U.S. Cl. 428/203; 428/201; 430/125.3

(57) ABSTRACT

A foiled article and methods of making the foiled article. The foiled article includes a substrate with one or more foiled areas on one or both surfaces of the substrate. The foiled areas are formed by applying a predetermined pattern of toner or ink to the substrate, and bonding a foil material to the patterned areas by the application of heat. The foiled areas can then be printed to create a multi-colored foil, images, or text thereon. The foiled areas can be simultaneously printed with the non-foiled areas. The digital patterning of the toner or ink, as well as the optional digital printing of the foiled areas allow for variable images without the expenditure for stamping dies and printing plates, such that a short-run product can be produced at lower cost with faster turn around times than traditional foiling processes.

### FIELD OF THE INVENTION

The present invention relates generally to foiled articles and foiling processes. More particularly, the present invention relates to foiled articles and processes of making foiled articles incorporating patterned foils using digital printing processes.

### BACKGROUND OF THE INVENTION

Foiling of articles, such as printed products, can add dramatic and compelling features to an otherwise plainly printed product. Such products can include, for example, greeting cards, business cards, posters, stamps, napkins, gift or identification cards, containers, currency, awards and certificates, pocket calendars, passports, books, and any of a variety of printed articles. A metallized or pigmented foil is applied or fused to at least a portion of the product. Such foiled products are known in the industry simply as “foils.”

Currently, these foils are fabricated using a methodology that requires several ink and foil press runs. One such methodology includes a hot foil printing process which includes stamping of the foil onto the substrate. Those involved in printing operations have used hot foil printing processes to stamp or emboss metallic, clear, or colored foils onto various substrates, such as paper, plastic, glass, rubber, and the like to produce the above mentioned articles.

Before the hot foil printing process can begin, the desired wording or design texture must be created on the face of a printing plate or die. Magnesium, copper, and various brasses are often used as a die material because of their high thermal conductivity. The designs are often etched onto the face of the die using a photo mask and acid, such as hydrochloric acid.

When using the acid etch process, the wording and/or designs can generally only be done in a single depth, as the depth is controlled only by the type and concentration of acid used and the etch duration. In addition, because the acid must chemically etch away the die material, processing times generally can exceed eight hours.

Another method of patterning the die includes laser etching of the die. The die is a composite die that is laser etchable, has a high thermal conductivity, and that can be used to produce images with high resolution in various thermal transfer media. Such laser etching process reduces the processing times required for acid etch processes, and also allows a multi-depth design to be created much easier than the acid etch process.

Once the die has been patterned, the die can be mounted onto a heated block, which is generally heated to an elevated temperature. As foil is transferred on a roll from a first full spindle or unwind to a second spent roll or rewind through a position intermediate the heated die and the substrate. The heated die can be pressed against the plastic foil substrate carrying the foil so that the foil comes into contact with the media with a specific pressure for a specific period of time. The combination of pressure, temperature, and duration enables the foil to be transferred from the foil roll to the substrate.

There are numerous inherent deficiencies with conventional dies. For example, the long processing times needed to create a design on a metal die can lead to significant turnaround times. Because the etching processing times can exceed eight hours, turnaround for any foil printing using such dies generally exceeds eight hours. If more than one design depth is desired, for instance, to add texture to the design, further etching must be performed, thus leading to additional processing times.

In addition, because there are inherent resolution limitations to using chemical etching to obtain a design on a die, the resolution of the acid-etched magnesium die can be generally low. Moreover, once the acid etching process is completed, the acid and treatment water must be disposed of, thus potentially causing an environmental concern.

When placing the magnesium die on the heated block, an adhesive layer is usually used on the back of the die. The die is generally manually positioned. This can lead to poor placement of the die. If a user desires to assure that the die is in correct positioning on the heated block, positioning or registering holes can be drilled or machined into the die. However, this requires an additional step beyond the acid etching process and can lead to additional time for turnaround of the die and/or substrate produced using the die.

Stamping dies created from both laser etching and acid etch processes are personalized dies designed specifically for each product, as well as personalized printing plates. Therefore, it is not economically viable to run short runs, i.e. for a small number or one-of-a-kind articles. Further, if multiple colored foils and/or designs are incorporated into the products, the processes require multiple die and/or foil changeovers, resulting in increased costs and significant production time slowing delivery of the product to the customer. These processes, whether single-pass or multi-pass, require strict tolerances, or registration accuracy, for foil-to-ink registration, thereby requiring precise register press equipment. This equipment and/or the added waste of products with unacceptable registration accuracy drive up the cost of the foiled products, and can compromise the quality of the finished product.

Dieless foiling processes eliminate the need for individual stamping dies. One such process is described in U.S. Application Publication No. 2005/0167035, now abandoned, to Lasket et al., incorporated herein by reference in its entirety, in which an adhesive is applied in a pattern to one of the substrate and the foil using a drop on demand deposition head, and then the foil and substrate are combined such that the transferable layer is transferred from the foil to the substrate. Another known process is using traditional offset printing techniques incorporating patterned printing plates to apply adhesive to a sheet or web. A cold foil, i.e. foil on a carrier, is applied to foil the adhesive areas. However, there are no variable image capabilities in this process because it incorporates static printing plates which must be fabricated for each individual printing job.

There is a current need for low cost, dieless foil printing processes incorporating variable image data and color techniques that address the problems and deficiencies inherent with conventional foil printing processes.

### SUMMARY OF THE INVENTION

The foiling processes of the various embodiments of the present invention resolves the above-described deficiencies and drawbacks inherent with stamping dies used in conventional foil printing processes by providing a dieless foil printing process that can combine short-run full-color digital printing with the properties of foil to create a new and unique product. The combination of digital printing with a dieless foil process incorporates the benefits of short-run full-color printing, such as, for example, short run and/or variable data abilities by print on demand technologies, thereby opening a window of opportunity to offer a dramatically expanded line of foiled products, or foils, including the offering of a gamut of foil colors and patterns.

In various embodiments of the present invention, a substrate is patterned or printed with toner, such as, for example, dark-colored or black toner, using digital printing processes. In the digital printing process, a digital image made up of a plurality of pixels is reproduced on a two-dimensional surface, i.e. the substrate, as each pixel corresponds to a specific position on the substrate surface. A foil material is introduced proximate the substrate patterned with ink or toner. Upon application of heat, the foil adheres to only the patterned areas. In one embodiment of the invention, a dimensional toner is used such that upon application of foil and heat, the dimensional toner raises and creates a three-dimensional pattern having a look similar to embossed foil.

In various embodiments of the present invention, the foil and substrate are simultaneously printed with one or more colors to create colored foil products without requiring multiple passes or pigmented foils, thereby reducing the need for precise foil registration accuracy from run to run and reducing the number of runs or passes, thereby producing a cost-effective and high quality product.

In another embodiment of the present invention, a varnish or clear coating, such as a UV-activated clear coating, is subsequently applied over at least a portion of the printed and/or unprinted foil. This clear coating reduces the removal of the foil or printed foil by scratching, rubbing, and the like.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

FIG. 1 is a top view depicting a foiled article according to an embodiment of the invention;

FIG. 2 is a cross-sectional view depicting a foiled article according to an embodiment of the invention; and

FIG. 3 is a block diagram of a digital foil printing process according to an embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

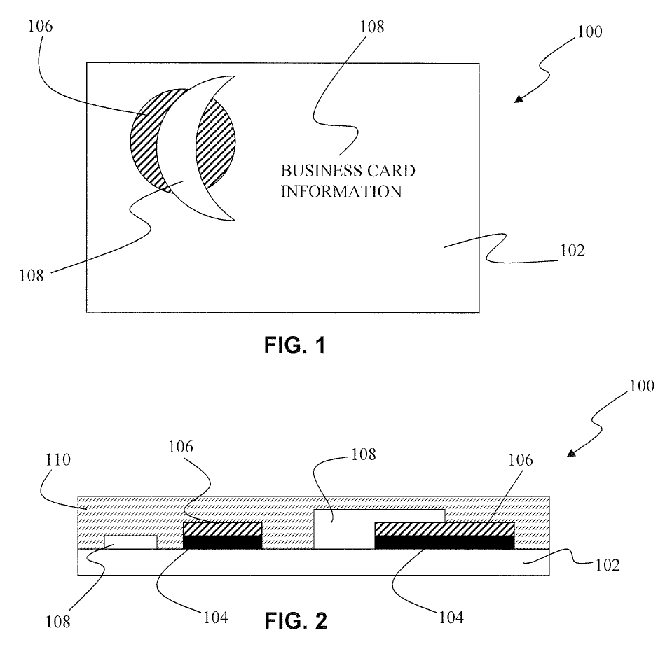

A foiled article or foil and a digital foil printing process for making such according to the present invention are depicted in FIGS. 1-3. Referring to FIGS. 1 and 2, a foiled article is shown generally at 100. Article 100 is depicted as a business card; however, article 100 can be any of a variety of articles including, but not limited to, greeting cards, business cards, identification cards, gift cards, currency, labels, napkins, posters, stickers, awards and certificates, pocket calendars, passports, books, folders, and the like. Article 100 comprises a substrate 102 such as, for example, paper, paperboard, cardboard, plastic, plastic film, glass, ceramics, fabric, metallized materials, and combinations thereof. Article 100 further comprises digitally patterned areas 104, such as toner areas, illustrated in FIG. 2, over at least a portion of one or both surfaces of substrate 102. Patterned areas 104 generally comprise a commercially available xerographic toner in black or a dark color. A foil material or foil laminate is fused or adhered to at least some of patterned areas 104 to create foil area 106. Foil area 106 can include text, graphics, emblems, security information, borders, and any of variety of designs or patterns.

Optionally, substrate 102 can comprise printed indicia 108 on one or both surfaces of substrate 102. Printed indicia 108 can include, for example, text, graphics, emblems, security information, magnetic stripes, bar codes, and combinations thereof. Printed indicia 108 can also be printed over at least a portion of foil area 106 to produce colored foils, imaged foils, patterned or textured foils, text, and combinations thereof. Printed indicia 108 can comprise any of a variety of suitable printing media, such as, for example, inks, toner, UV-curable inks, and combinations thereof.

A clear coating 110, such as a UV coating or a varnish, can then optionally be applied over at least a portion of foil areas 106 and substrate 102 to protect foil areas 106 and/or printed indicia 108 from being removed or scratched off from substrate 102. In one embodiment of the invention, clear coating 110 comprises a UV-curable clear varnish.

In an alternative embodiment of the invention, a raised printing process, such as raised thermography, can be used to form patterned area 104. For example, at least some of patterned area 104 comprises a dimensional toner, or a toner that takes on a raised or three-dimensional appearance upon activation by heat, radiation, or the like. One such suitable dimensional toner is NEXPRESS Dimensional Clear Drylnk available from Kodak. To create an embossed look to foil area 106, a combination of standard toner and dimensional toner can be applied to substrate 102. The dimensional toner can be applied in discrete areas from the standard toner, over the standard toner, or combinations thereof. The foil is then applied, and the toner is activated with heat to create a raised image area only where the dimensional toner is applied. The foil then fuses to both the standard toner areas and the dimensional toner areas to create a dimensional or textured foil area.

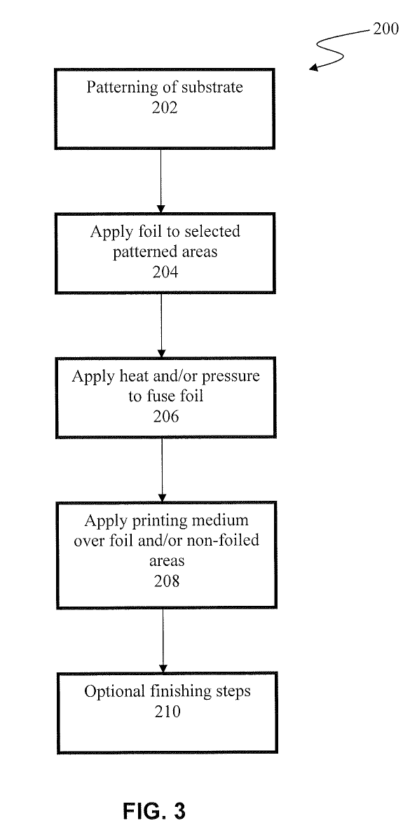

Referring to FIG. 3, a process for fabricating a foiled article 100 is generally depicted at 200. Process 200 can be a continuous web process, a batched sheet-fed process, or a combination thereof. At digital patterning step 202, a substrate 102 is patterned on one or both major surfaces with one or more ink or toner materials, including standard toner, dimensional toners, and combinations thereof, to form patterned areas 104 representative of a predetermined digital image. The digital image is a representation of a two-dimensional image using binary code. The digital image is made up of a plurality of pixels, each pixel corresponding to a specific position in a two-dimensional region. The digital image file is stored in a computer's memory, and is communicated, upon request, to the digital press. Each pixel of the digital image file then ultimately corresponds to a specific position on a surface of substrate 102.

A digital image file can be saved for each individual client or order, and can be quickly accessed or edited upon request.

The toner or ink material can be applied by one or more digital printing presses, such as a xerographic press. In one embodiment of the invention, the toner can be applied using a commercially available xerographic press such as, for example, Hewlitt Packard's HP Indigo digital presses, Xerox's iGen presses, and Kodak's NexPress digital presses, Xante digital presses, and combinations thereof.

A xerographic process is otherwise known as electrophotography. In xerography, an electrostatic charge is uniformly distributed over an external surface of a drum or belt, such as by a corona discharge or a contact roller with a charge applied to it. The drum or belt is manufactured from materials that hold an electrostatic charge in the dark, but conduct away the charge under light. The image to be printed is passed over a lens so that the image is projected onto the drum or belt while moving, exactly with the moving drum or belt surface, creating a mask. Areas of the drum or belt remain unlit that correspond to text or image areas of the digital image to be printed. Where there is no image or text, the drum will be illuminated and the charge will be dissipated. The charge that remains on the drum or belt is called the “latent image” and is a positive of the original digital image.

The drum or belt is then presented with toner material including plastic toner particles and larger, metallic carrier particles. By contact with the carrier, each toner particle has an electric charge of polarity opposite to the charge of the latent image on the drum or belt. The charge then attracts toner to form a reproduction of the digital image on the drum or belt. The substrate to be printed is then passed between the imaged drum or belt and a transfer corona, which has a polarity that is opposite the charge on the toner. The toner image is then transferred onto the substrate by electrostatic attraction.

In foiling step 204, one or more foil materials are introduced proximate one or both surfaces of substrate 102, specifically proximate surfaces containing patterned areas 104, using a foiling press. In embodiments in which toner is used to created patterned areas 104, upon application of heat and/or pressure or a radiant fusing technology to melt the toner particles, the toner melts as it is made up of small particles of plastic. Patterned areas 104 are then permanently fixed to substrate 102 using either a heat and/or pressure mechanism in step 206, and the foil fuses to these patterned areas 104 creating foil areas 106. One such foiling press is the Automatic Foil-Tech Foil Fuser available from Therm-o-Type Corporation. However, this press is limited to sheet-fed applications. Foil presses for web applications can also be incorporated.

In printing step 208, at least a portion of foil areas 106 and optionally non-foiled areas of substrate 102 are printed using any of a variety of suitable printing techniques, such as, for example, flexography, lithography, digital printing such as inkjet and dot-matrix printing, gravure, rotogravure, offset printing, intaglio, laser printing, screen printing, xerographic printing, and the like and combinations thereof. In particular embodiments, one or more digital printing techniques are incorporated in printing step 208. In one embodiment of the invention, at least a portion of foil area 106 and substrate 102 are printed using standard xerographic processes and presses with toners as described above such that no printing plates are incorporated into the process. In another embodiment of the invention, one or more digital inkjet printers can be used with inks, such as, for example, at least a portion of foil area 106 and substrate 102 are printed using one or more UV-curable inks via one or more digital drop-on-demand inkjet presses. Suitable UV curable inks include, but are not limited to, SUNCURE inks commercially available from Sun Chemical of Carlstadt, N.J., and UV curable inks commercially available from Flint Inks of St. Paul, Minn. Other suitable printing materials or media can include toners, water- or solvent-based inks, solventless inks, other forms of radiation curable inks, and combinations thereof. Printed indicia 108 can be subsequently cured using one or more cure stations. Suitable cure stations can include, for example, UV curing, LED lights, heat or IR curing, near infrared (NIR) curing, E-beam curing, dryers, microwave, and any suitable curing station or combinations thereof.

Foil areas 106 and non-foiled areas of substrate 102 can be printed simultaneously or in series using one or more presses. In an alternative embodiment of the invention, substrate 102 is printed before digital patterning step 202 and foiling step 204. Then at printing step 208, printing of foil areas 106 and additional printing of substrate 102 can be performed.

At step 208, optional finishing processes can be performed such as, for example, coating, curing, converting, additional printing, encoding, and the like. In one embodiment of the invention, a clear coating 110 is applied over at least a portion of foil areas 106 and substrate 102 to prevent or inhibit removal of foil areas 106 and printed indicia 108. Clear coating 110 can be applied by any of a variety of suitable processes such as, for example, digital ink jet, gravure, curtain coating, extrusion, and combinations thereof. Clear coating 110 can be either flood coated or spot coated. Clear coating 110 can optionally be cured using one or more cure stations. Suitable cure stations can include, for example, UV curing, LED lights, heat or IR curing, near infrared (NIR) curing, E-beam curing, dryers, microwave, and any suitable curing station or combinations thereof.

Other optional finishing processes can include additional printing over clear coating 110, patterning or embossing of clear coating 110, printing of a non-foiled surface of substrate 102, curing of additional printing, laminating to additional substrates, converting into finished products, magnetic striping by lamination or printing, and other suitable finishing techniques.

The above process 200 allows for a cost effective method of manufacturing a high quality, cost effective, foiled article 100 that is compelling and unique. In one embodiment of the invention, a standard foil, such as a silver foil, is applied to substrate 102. The standard foil is generally lower in cost than pigmented foils. The standard foil can then be pigmented by printing using one or more colors, in a single printing step using one or more presses, such as a 4 color press (4-CP), rather than requiring the use of differently colored foils and multiple runs or steps to create a multi-colored foiled area. Any of a number of colors can be used, as it is not limited to the pigmented foils commercially available.

Process 200 is more cost effective than traditional foiling processes because process 200 eliminates waste as foil is only applied to toner patterned areas, or spot foiled, and the strict registration accuracy required in from traditional die stamping processes is no longer required. Further, because the toner is applied using print on demand or digital techniques, it eliminates the expense of creating a personalized stamping die for each product, thereby allowing for variable image and data runs, as well as creating a economically viable short run of product. Rather, the images or patterns to be printed are loaded or created, and stored via computer, which is subsequently communicated to the digital press, and can be quickly and readily changed. Even yet, the ability to digitally print the toner and apply the foil allows for shorter set-up times, and quicker turn-around time of orders. Virtually each and every one, or 100% of the images, including patterns, graphics, and text, can be readily changed, added, or eliminated, such that a single article, or one of a kind article, can be easily printed, while quickly changing to the next desired image to be printed.

In addition, if printing step 208 is done using print on demand or digital processes, such as inkjet or xerographic processes, this further reduces the expenditure because it no longer requires the fabrication of personalized printing plates for each product. Again, the desired printed indicia is loaded and stored via computer, and subsequently communicated to the digital press, and can also be quickly and readily changed, added, or eliminated. Printing resolutions also tend to be higher for digital presses than standard plate presses and stamping dies, thereby creating a higher quality image.

Finally, process 200 can be done in a single inline process, including printing presses, foiling presses, curing stations, and other inline capabilities in one pass, which allows for high speed applications with fewer processes steps, further reducing costs. In one embodiment of the invention, process 200 is a web process including one or more print stations, a foiling station, optional coating or printing station, optional curing stations, and other finishing stations such that substrate 102 and the foil material are introduced in roll or web form. Web speeds can be from about 200 feet per minute or less up to about 1000 feet per minute, and web widths can be from about eight inches up to as wide as about 40 inches, particularly advantageous for larger runs.

The invention may be embodied in other specific forms without departing from the essential attributes thereof; therefore, the illustrated embodiments should be considered in all respects as illustrative and not restrictive.

What is claimed is:

1. A method of fabricating a foiled article using digital patterning, the method comprising:
providing a substrate presenting a surface;
applying toner material to at least a portion of the surface of the substrate in a toner pattern representative of a digital image comprising a plurality of pixels, wherein a pixel of the digital image corresponds to a defined position on the surface of the substrate;
bonding foil material to the toner pattern upon application of heat, such that the surface comprises at least one foiled area and at least one non-foiled area; and
printing indicia on at least a portion of the at least one foiled area.

2. The method of claim 1, wherein the printing further comprises printing indicia simultaneously on at least a portion of the at least one foiled area and at least a portion of the at least one non-foiled area.

3. The method of claim 1, wherein printing the indicia comprises one or more printing processes selected from the group comprising flexography, lithography, inkjet, gravure, rotogravure, offset printing, intaglio, laser printing, screen printing, xerographic printing, and combinations thereof.

4. The method of claim 3, wherein the printing process comprises a xerographic process.

5. The method of claim 1, wherein indicia is selected from the group consisting of text, color, graphics, images, patterns, and combinations thereof.

6. The method of claim 5, wherein the foil material comprises a foil, and wherein printing indicia comprises printing one or more colors to produce a colored foil.

7. The method of claim 1, further comprising, after bonding foil material to the toner pattern:
applying a transparent layer over at least the printed foiled areas.

8. The method of claim 7, wherein the transparent layer comprises a radiation-curable coating, and after applying the radiation-curable coating, the method further comprises:
curing the radiation-curable coating with one or more sources of actinic radiation.

9. The method of claim 8, wherein the transparent layer comprises a UV-curable varnish, and the one or more sources of actinic radiation comprise UV-curing stations.

10. The method of claim 1, further comprising, prior to bonding of the foil material to the toner pattern:
printing indicia over at least a portion of the surface of the substrate.

11. The method of claim 1, wherein applying toner material comprises an electro-photographic or xerographic process.

12. The method of claim 1, wherein the substrate comprises paper, paperboard, cardboard, plastic, plastic film, glass, ceramics, fabric, metallized materials, laminates, and combinations thereof.

13. The method of claim 1, wherein the toner material comprises a combination of non-dimensional toner and dimensional toner adapted to form a raised image upon activation, such that the at least one foiled area comprises raised and non-raised areas upon application of heat.

14. A foiled article comprising:
a substrate presenting a surface;
a toner material applied in a pattern to at least a portion of the surface of the substrate, wherein the pattern is representative of a digital image comprising a plurality of pixels, wherein each pixel of the digital image corresponds to a defined position on the surface of the substrate;
a foil material bonded to the toner material to define a predetermined pattern of at least one foiled area and at least one non-foiled area; and
printed indicia bonded to at least a portion of the at least one foiled area and the at least one non-foiled area.

15. The foiled article of claim 14, wherein the substrate comprises paper, paperboard, cardboard, plastic, plastic film, glass, ceramics, fabric, metallized materials, laminates, and combinations thereof.

16. The foiled article of claim 14, wherein the foil material bonds to the toner material upon application of heat.

17. The foiled article of claim 14, wherein the toner material is applied by an electro-photographic or xerographic process.

18. The foiled article of claim 14, wherein the toner material comprises a combination of non-dimensional toner and dimensional toner adapted to form a raised image upon activation, such that the at least one foiled area comprises both raised and non-raised areas.

19. The foiled article of claim 14, the article further comprising:
a transparent coating covering at least the at least one foiled area.

20. The foiled article of claim 19, wherein the transparent coating comprises a UV-cured varnish covering an entirety of the at least one foiled area and the at least one non-foiled area.

21. The foiled article of claim 14, further comprising printed indicia bonded to at least a portion of the at least one foiled area and the at least one non-foiled area.

22. The foiled article of claim 21, wherein the printed indicia comprises text, color, graphics, images, patterns, and combinations thereof.

23. The foiled article of claim 21, wherein the printed indicia is printed by one or more printing processes selected from the group comprising flexography, lithography, inkjet, gravure, rotogravure, offset printing, intaglio, laser printing, screen printing, xerographic printing, and combinations thereof.

24. The foiled article of claim 23, wherein the printing process comprises electro-photographic or xerographic printing.

25. The foiled article of claim 14, wherein the article comprises a greeting card, business card, poster, stamp, napkin, gift card, identification card, container, label, currency, certificate, diploma, calendar, passport, or book.
